(19) United States
(12) Patent Application Publication
(10) Pub. No.: US 2006/0029257 A1
(43) Pub. Date: Feb. 9, 2006

(54) Apparatus for determining a surface condition of an object

(75) Inventors: Junji Eguchi, Saitama (JP); Manabu Murakami, Saitama (JP)

Correspondence Address: Brian M. Berliner;O'MELVENY & MYERS LLP, 400 So. Hope Street, Los Angeles, CA, 90071-2899, US

(73) Assignee: Honda Motor Co., Ltd.

(21) Appl. No.: 11/181,643

(22) Filed: Jul. 13, 2005

(30) Foreign Application Priority Data
Aug. 3, 2004 (JP) 2004-226652
Aug. 3, 2004 (JP) 2004-226658
Aug. 4, 2004 (JP) 2004-228097
Aug. 4, 2004 (JP) 2004-228116
Aug. 4, 2004 (JP) 2004-228131

(51) Int. Cl. G06K 9/00

(52) U.S. Cl. 382/108

(57) ABSTRACT

The present invention provides an apparatus and a method for determining a surface condition of an inspected object. A potential region having an intensity different from the other regions by more than a predetermined threshold value in an object image captured by an imaging device is detected. An inspected region surrounding the potential region is identified. A feature for a parameter is extracted from the inspected region. The surface condition is determined based on the feature. The parameter includes one or more of an area of the potential region, a slope of the potential region, an intensity value entropy of the inspected region, an intensity value anisotropy of the inspected region, an average intensity value of an edge image of the inspected region, and a roundness of the potential region.

### BACKGROUND OF THE INVENTION

The present invention relates to an apparatus and method for determining a surface condition of an inspected object through an image analysis.

In many cases, a visual inspection of a manufactured product such as a gear is performed so as to inspect a surface condition such as a defect (blemish) or the like. Although work for the visual inspection is simple, higher attention is required for the work. Accordingly, it is difficult to detect a defect by the visual inspection. Thus, there is a need for an apparatus that can inspect a manufactured product without relying on the visual inspection.

Japanese Patent Publication No. S63-201556 discloses a method for obtaining images of gear teeth surfaces, evaluating the intensity of the obtained images, and determining presence/absence of a defect such as a dent or the like on the gear teeth surfaces. According to this method, different teeth surfaces of a gear that is to be inspected are imaged from the substantially same direction. Thus, a plurality of images are captured for the gear. The images are compared to each other to generate differential images, each of which represents an intensity difference between the images. These differential images are added together to generate a summed image. The intensity of the summed image is compared with a reference value to determine a presence/absence of a dent.

Japanese Patent Publication No. 2002-109541 discloses a method for using a neural network to generate a self-organizing map from images of an inspected object, forming clusters each having neurons corresponding to the same image, and identifying the object by using the clusters.

Japanese Patent Publication No. 2003-44835 discloses a method for capturing images of a plurality of inspected objects, and using as input data the position and intensity of each of pixels constituting the images to generate a self-organizing map. This self-organizing map is regarded as master data. A go/no-go test for the inspected object is performed based on the consistency between an image of the inspected object and the master data.

In an image thus captured, a region that does not exhibit a defect but has the intensity different from the other regions may be detected. Such an image region having the intensity different from the other regions is detected due to, for example, color unevenness on the surface of a manufactured product such as a gear and is called an “over-detection” region. According to the method disclosed in Japanese Patent Publication No. S63-201556, many over-detection regions may be detected and hence considerable visual inspection work may be required so as to differentiate a defect from such over-detection regions.

According to the method disclosed in the Japanese Patent Publication No. 2002-109541, the object is a human-being. Therefore, this method is not appropriate for determining the surface condition of a manufactured product such as a gear.

The method disclosed in Japanese Patent Publication No. 2003-44835 requires the master data for each object to be inspected because go/no-go test for the object is performed based on a difference between the master data and an image of the inspected object. This method is based on an assumption that a surface profile of an inspected object that passes the test is pre-determined. Such an assumption may not be satisfied when an object such as a gear is inspected because over-detection regions (for example, color unevenness or crud on the surface) irregularly appear and exhibit various shapes. Accordingly, this method cannot be applied to an inspection of an object such as a gear.

### SUMMARY OF THE INVENTION

The present invention provides an apparatus and a method for determining a surface condition of an inspected object.

According to one aspect of the present invention, a potential region having an intensity different from the other regions by more than a predetermined threshold value in an object image captured by an imaging device is detected. An inspected region surrounding the potential region is identified. A feature for a parameter is extracted from the inspected region. The surface condition is determined based on the feature.

According to the invention, a potential region is detected as a region that potentially has a predetermined surface condition such as a defect. The inspected region surrounding the potential region is identified. Since the surface condition is determined based on the feature for a parameter extracted from the inspected region, the accuracy of the determination can be improved.

According to one embodiment of the invention, the parameter includes one or more of an area of the potential region, a slope of the potential region, an intensity value entropy of the inspected region, an intensity value anisotropy of the inspected region, an average intensity value of an edge image of the inspected region, and a roundness of the potential region. Through use of these parameters, the accuracy of determining the surface condition can be improved.

According to another aspect of the present invention, a surface condition of an inspected object having consecutive units of similar texture on the surface is determined. As the inspected object is rotated relatively to the imaging device, the consecutive units are sequentially imaged. A difference between a current image and a previous image is determined. In the differential image, a potential region having an intensity exceeding a predetermined threshold value is detected. An inspected region surrounding the potential region is identified. The surface condition is determined based on a feature extracted for a plurality of predetermined parameters from the inspected region.

This invention handles an object that has consecutive units of similar texture on its surface. Such an object is, for example, a gear and the consecutive units are teeth of the gear. The object is rotated relatively and an image of the object is captured. A differential image is determined from the images. A region having an intensity exceeding a threshold value is extracted from the differential image. Since two images having no defect contain substantially same texture units, the intensity of the differential image between the two images is small. In contrast, when either one or both of two images include a defect, the defect appears in the differential image as a region having a larger intensity. Thus, by determining the differential image, the surface condition can be accurately determined.

According to another aspect of the present invention, a data map is generated to be used for determining a surface condition of an inspected object having consecutive units of similar texture. The generation of the data map includes extracting a feature vector from each of a plurality of samples of the inspected region, self-organizing learning by using as input data the feature vectors to generate a self-organizing map, grouping neurons that correspond to a same sample and are adjacent to each other into a cluster in the self-organizing map, and classifying one or more clusters as corresponding to a predetermined surface condition and the other clusters as corresponding to another predetermined surface condition. Thus, the data map is generated.

According to this aspect of the invention, a data map to be used for automatically determining a surface condition of an inspected object having consecutive units of similar texture (for example, texture or pattern of the surface) is generated by self-organizing learning of a neural network. Therefore, a highly-reliable determination data map can be obtained. According to one embodiment, in the data map, one or more clusters are classified as corresponding to a defect (such as dent, crack, or cut) and the other one or more clusters are classified as corresponding to an over-detection (such as surface unevenness, stain, or color unevenness).

According to one embodiment of the invention, a surface condition of an object is determined by using the above described data map. The determination includes determining a differential image between a current image and a previous image in the consecutively-captured images, detecting a potential region having an intensity exceeding a predetermined threshold value in the differential image to identify an inspected region surrounding the potential region, extracting a feature vector from the inspected region, calculating a distance between the feature vector and a coupling coefficient vector of each neuron in the data map, determining a region of adjacent neurons having a small distance, and determining the surface condition based on the number of neurons that are in the determined region and belong to one of the clusters as corresponding to a predetermined surface condition. Thus, a highly-reliable determination can be performed.

According to yet further aspect of the present invention, a plurality of data maps are provided for respective parts of the inspected object. Each of the data maps learns a surface condition at the corresponding part of the inspected object. An inspected region is set to include a potential region having an intensity different from the other regions in a captured image by more than a predetermined threshold value. A feature vector is extracted from the inspected region. A part to which the inspected region belongs is identified to select a data map corresponding to the identified part. The feature vector is input into the selected data map to determine whether the inspected region has a predetermined surface condition.

According to this aspect of the invention, data maps in which a surface condition such as a defect (dent, crack or cut) is learned for each part of the object are used to determine the surface condition of the corresponding part. Therefore, determination for each part of the object can be efficiently performed without increasing the time required for the determination.

According to yet further aspect of the present invention, a potential region having an intensity different from the other regions in the image by more than a predetermined threshold value is detected. An inspected region surrounding the potential region is identified. Then, if the inspected region is identified at the same position of the object in a plurality of consecutive images, it is determined that a predetermined surface condition is included in the inspected region.

A predetermined surface condition such as a defect (for example, dent, crack, cut, or the like) on an object reflects an illumination light in various directions, differently from an over-detection region such as color unevenness or stain. Such a predetermined surface condition has the characteristics that it is detected at the same part on the object over a plurality of consecutive images. By determining whether or not the predetermined surface condition has been identified at the same position on the object over a plurality of consecutive images, the time required for the determination can be shortened and the determination can be efficiently performed.

According to yet further aspect of the present invention, a cause of a predetermined surface condition of an inspected object is automatically determined. A cause seeking map is provided in advance. In the cause seeking map, which is a self-organizing map, neurons are clustered for each of the causes of the surface condition. Then, a potential region having an intensity different from the other regions in the image by more than a predetermined threshold value is detected. An inspected region surrounding the potential region is identified. It is determined whether or not the inspected region includes a predetermined surface condition. Position information of the inspected region determined as including the predetermined surface condition is identified. From the identified position information, a position vector representing a position of the predetermined surface condition on the object is extracted. The extracted position vector is input into the cause seeking map. A distance between the position vector and a coupling coefficient vector for each neuron is calculated. A neuron having a minimum distance is identified in the cause seeking map. A cause of the predetermined surface condition is determined in accordance with a cluster to which the identified neuron belongs.

According to this aspect of the invention, a cause of a predetermined surface condition can be automatically identified from the position information of the inspected region. Because the cause of the predetermined surface condition is automatically identified, it is efficiently determined which process regarding the object needs to be improved in terms of management.

### BRIEF DESCRIPTION OF THE DRAWINGS

FIG. 1 is a block diagram of an overall structure of an imaging device for gear teeth surfaces in accordance with one embodiment of the present invention.

FIG. 2 is a block diagram showing an overall structure of an image processing computer in accordance with one embodiment of the present invention.

FIG. 3 shows a relationship between a potential defect region and an inspected region in accordance with one embodiment of the present invention.

FIG. 4 shows intensity value histograms where entropies are different, in accordance with one embodiment of the present invention.

FIG. 5 shows intensity value histograms where anisotropies are different, in accordance with one embodiment of the present invention.

FIG. 6 shows feature vectors in accordance with one embodiment of the present invention.

FIG. 7 is a flowchart of a process for determining a surface condition of a gear tooth in accordance with one embodiment of the present invention.

FIG. 8 schematically shows a partial structure of a neural network in accordance with one embodiment of the present invention.

FIG. 9 schematically shows a generation process of a self-organizing map in accordance with one embodiment of the present invention.

FIG. 10 schematically shows a clustered self-organizing map in accordance with one embodiment of the present invention.

FIG. 11 schematically shows a determination data map generated from a self-organizing map in accordance with one embodiment of the present invention.

FIG. 12 schematically shows a defect determination using a determination data map in accordance with one embodiment of the present invention.

FIG. 13 illustrates position information of an inspected region in accordance with one embodiment of the present invention.

FIG. 14 illustrates a center region and an end region of a gear in accordance with one embodiment of the present invention.

FIG. 15 is a flowchart of a process for determining a surface condition of a gear tooth in accordance with one embodiment of the present invention.

FIG. 16 is a flowchart of a process for selecting a determination data map in accordance with one embodiment of the present invention.

FIG. 17 illustrates a first determination of a defect in accordance with one embodiment of the present invention.

FIG. 18 is a block diagram showing an overall structure of an image processing computer in accordance with one embodiment of the present invention.

FIG. 19 shows a map generated based on data regarding an inspected region in accordance with one embodiment of the present invention.

FIG. 20 is a flowchart of a process for determining a surface condition of a gear tooth in accordance with one embodiment of the present invention.

FIG. 21 is a block diagram showing an overall structure of an image processing computer in accordance with one embodiment of the present invention.

FIG. 22 shows a cause seeking map in accordance with one embodiment of the present invention.

FIG. 23 shows a defect position vector for learning in accordance with one embodiment of the present invention.

FIG. 24 is a flowchart of a main routine for determining a cause of a surface condition of a gear tooth in accordance with one embodiment of the present invention.

FIG. 25 is a flowchart of a subroutine for determining a cause of a surface condition in accordance with one embodiment of the present invention.

### DESCRIPTION OF THE PREFERRED EMBODIMENTS

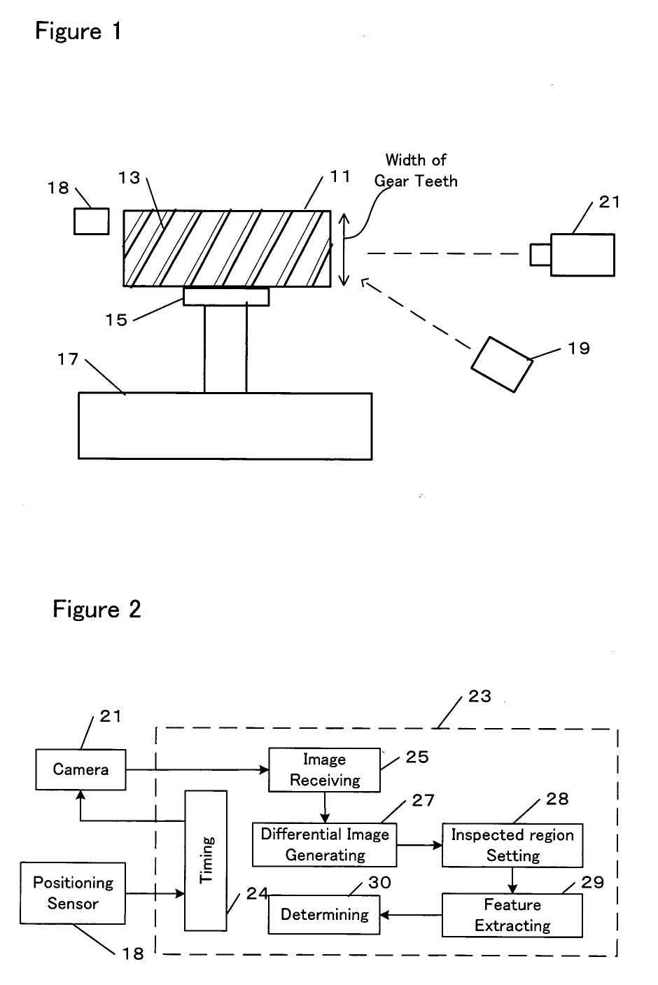

Some embodiments of the present invention will be described referring to the accompanying drawings. In the following embodiments, an object to be inspected is a gear. FIG. 1 shows a structure of an imaging apparatus where an object to be inspected is a gear 11. The gear 11 is attached to a rotary table 15. The gear 11 is rotated stepwise by a pitch of the gear teeth by a stepper motor (not shown) mounted in a base 17. The gear 11 is illuminated by an illumination device 19. A camera 21 having a CMOS image sensor images a tooth surface of the gear 11. The image is caught in synchronization with the stepwise rotation of the gear 11. One static image is captured each time the gear 11 is rotated by one step. In one embodiment, the illumination device 19 uses a blue light-emitting diode. Alternatively, another illumination device such as a lamp or the like may be used. By using, as the camera 21, a wide dynamic range CMOS camera having a wide range of the measurable intensity, a desirable image appropriate for determining the surface condition of a gear tooth can be obtained. Depending on the object, a camera having a CCD image sensor may be used.

A positioning sensor 18, which is generally called a proximity sensor, generates a high frequency magnetic field by its detection coil. When a metal object approaches this magnetic field, induced current (eddy current) flows through the object due to electromagnetic induction. Impedance of the detection coil changes by this electric current and the generation of the high frequency is stopped. As a result, the approach of the object is detected. In this embodiment, the approach of the top of each gear tooth is detected by the proximity sensor. A signal from the positioning sensor 18 is sent to a computer 23 (shown in FIG. 2). A timing unit 24 of the computer 23 transmits a signal to the camera 21 in accordance with the detection of the gear tooth. In response to the transmitted signal, the camera 21 captures an image of the gear.

FIG. 2 shows a functional block diagram of the computer 23 for processing images caught by the camera 21. The computer 23 may be a personal computer, a workstation or other computers. The computer 23 can be provided with a processor (CPU) for performing calculations, a storage device for storing various data and programs, an input device such as a mouse and/or a keyboard for enabling a user to input data to be processed by the processor, and an output device such as a display for displaying results processed by the processor and/or a printer for printing results processed by the processor. The storage device may include a memory such as ROM and RAM and an auxiliary storage device such as a disk device. Processes implemented in the functional blocks shown in FIG. 2 are performed by the processor.

An image receiving unit 25 receives an image captured at every pitch of the gear teeth and provides the received image to a differential image generating unit 27. The differential image generating unit 27 calculates a difference between the currently-captured image and the previously-captured image (which is an image of the gear tooth surface one pitch before). If there is no defect such as a dent or cut on the gear, every part of the gear has about the same surface condition. Therefore, a differential image where the intensity is entirely small is generated. If there is a defect on the gear, the defect appears as a region having large intensity in the difference image because the intensity of the defect region is different from the intensity of the other regions.

When a difference between two images is taken, some pixels in the differential image may have a negative value for the intensity. Therefore, the intermediate intensity value of 128 is added to the intensity of the all pixels in the differential image, so that the intensity value for each pixel is positive. If the intensity value for a pixel exceeds 255 after the addition of 128, the intensity value for the pixel is set to 255. If the intensity value for a pixel is still negative after the addition of 128, the intensity value for the pixel is set to zero. Thus, the intensity value for each pixel in the differential image is arranged within a range from 0 to 255.

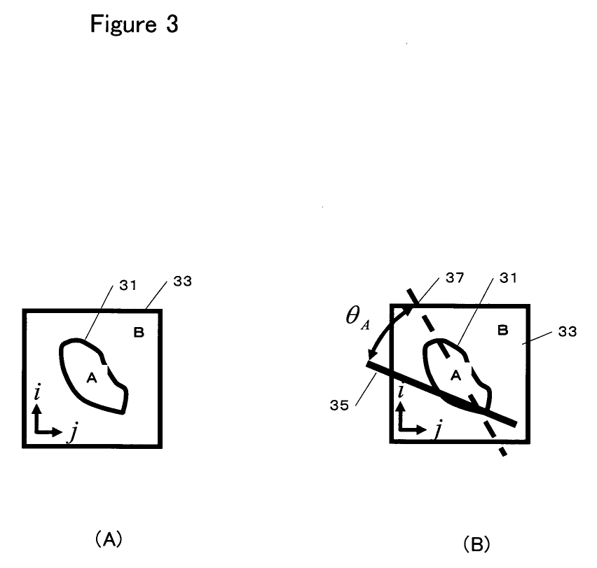

Referring to FIG. 3(A), an inspected region setting unit 28 detects a region having an intensity value larger than a threshold value in the differential image as a potential defect region (also called as a determination region) 31 and then sets a region 33 surrounding this region 31 as an inspected region. Although the shape of the inspected region 33 is a quadrangle in this embodiment, it may be another polygon or a circle or an ellipse. The size of the inspected region 33 is set sufficient to surround the potential defect region 31.

A feature extracting unit 29 extracts the following six parameters.

(1) Area S_{A} of the Potential Defect Region 31

The inspected region is expressed by a coordinate system with a vertical axis i and a horizontal axis j. Then, the area (size) SA of the potential defect region 31 is calculated by integral calculation using coordinates of the boundary of the potential defect region 31.

(2) Slope θ_{A} of the Major Axis Relative to the Tooth Lead when the Potential Defect Region 31 is Approximated by an Ellipse

A dent, which often appears in the gear, can be approximated by an ellipse. In FIG. 3(B), an approximate equation of an ellipse that approximates the potential defect region 31 is determined by using an appropriate approximate program used for graphics. The approximate equation can be determined by using a known program. Typically, the approximate equation is determined by a multivariate nonlinear least square fitting program. An angle OA formed between the major axis 37 of the ellipse thus determined and a straight line 35 that is parallel to the tooth lead 13 (FIG. 1) of the gear is calculated.

(3) Intensity Value Entropy entB of the Inspected Region 33

The entropy of intensity values of the inspected region 33, which includes the potential defect region 31, is calculated by the following equation (1). The entropy of the intensity values indicates information quantity of the intensity value distribution. As the information quantity is larger, it indicates that the randomness of the intensity value distribution is larger.

$$entB = - {\sum }_{0}^{255} rel [ p ] log ( rel [ p ] ) \qquad ( 1 )$$

In this embodiment, the randomness of the intensity value distribution including the intensity values from 0 to 255 is used as the entropy of the intensity values. In the equation (1), p represents an intensity value and rel[p] represents a frequency of the intensity value p.

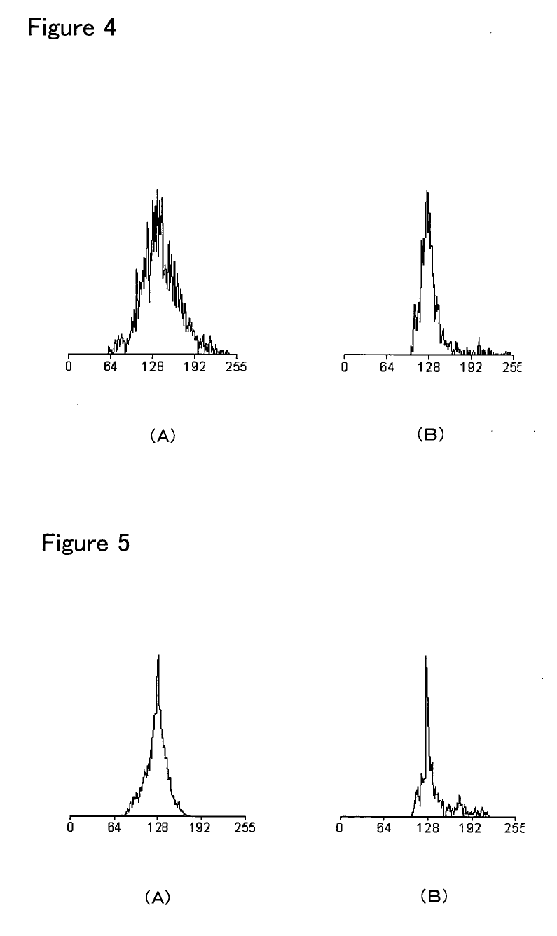

FIG. 4 shows an example of an intensity value histogram. In the case where a gear tooth surface has a defect, its intensity value entropy is relatively large because the defect appears in the differential image as a region having a variety of intensity values. FIG. 4(A) shows an intensity value histogram for an image in which pixels having different intensity values exist at random. Intensity values are widely distributed around the intermediate intensity value 128, so the entropy is large. FIG. 4(B) shows an intensity value histogram for an image in which variation in the intensity value is small. In this case, the entropy is small.

(4) Intensity Value Anisotropy ansB of the Inspected Region 33

The anisotropy of intensity values of the inspected region 33 is expressed by the following equation (2). The anisotropy indicates the degree of symmetry of the intensity value distribution.

$$ansB = \frac{{\sum }_{0}^{k} rel [ p ] log ( rel [ p ] )}{- {\sum }_{0}^{255} rel [ p ] log ( rel [ p ] )} \qquad ( 2 )$$

In the equation (2), k represents an intensity value whose appearance frequency is minimum. In other words, ansB is a value obtained by dividing the intensity value entropy from 0 to the minimum intensity value in the inspected region 33, by the intensity value entropy for all the intensity values starting from 0 in the inspected region 33. When the intensity value distribution is symmetrical with respect to the intermediate intensity value of 128, ansB is −0.5. As ansB approaches −0.5, the symmetry is higher and the anisotropy is smaller. As ansB leaves −0.5 and approaches 0 or −1, the symmetry is lower and the anisotropy is larger.

Referring to FIG. 5(A), an intensity value histogram is shown. The symmetry is high and the anisotropy is small because the intensity values are distributed evenly around the intermediate value of 128. On the other hand, in an intensity value histogram as shown in FIG. 5(B), the distribution of the intensity values is different between the left and right sides with respect to the intermediate value of 128. Therefore, the symmetry is low and the anisotropy is large. Assuming that the intensity value having the minimum appearance frequency is 230 in the example shown in FIG. 5(B), ansB has a value close to −1.

(5) Roundness C_{A} of the Potential Defect Region 31

Roundness C_{A} of the defect region 31 is expressed by the equation (3).

$${C}_{A} = \frac{{S}_{A}}{π {r}_{max}^{2}} \qquad ( 3 )$$

In the equation (3), S_{A} represents the area (size) of the potential defect region 31 and rₘₐₓ represents the maximum distance from the center of gravity of the potential defect region 31 to the edge of the inspected region 33.

(6) Average Intensity edgB of an Edge Image of the Inspected Region 33

Assumed that S_{B} represents the area (size) of the inspected region 33, an average intensity value edgB of an edge image of the inspected region 33 is calculated by the equation (4).

$$edgB = \frac{\sum Δ P ( i , j )}{{S}_{B}} \\ Δ P ( i , j ) = \sqrt{{( P ( i + 1 , j ) - P ( i - 1 , j ) )}^{2} + {( P ( i , j + 1 ) - P ( i , j - 1 ) )}^{2}} \qquad ( 4 )$$

In the equation (4), i and j represent coordinates of a pixel and P(i, j) represents an intensity value of the pixel at (i, j). ΔP (i, j) is a square root of a sum of a square of a difference between the intensity values of two pixels adjacent to P(i, j) in the vertical axis (namely, in the i-axis direction) and a square of a difference between the intensity values of two pixels adjacent to P(i, j) in the horizontal axis (namely, in the j-axis direction). Accordingly, ΔP(i, j) indicates the magnitude of a difference in the intensity values of the adjacent pixels. Calculation of the difference in the intensity values of the adjacent pixels is equivalent to generation of an edge image in which edge portions of the image that have large variations in the intensity value are enhanced. edgeB represents an average intensity of the edge image, which is calculated by dividing a sum of the magnitudes of differences in the intensity values of adjacent pixels by the area of the inspected region 33, as shown in the equation (4).

Each of the above-calculated six parameters is normalized according to the equation (5) by using the maximum and minimum values of the parameter, which have been extracted from many samples of the inspected region 33.
Normalization=(calculated value−minimum)/(maximum−minimum) (5)

Through this normalization, each parameter takes a value within a range from 0 to 1. Thus, the inspected region 33 including the potential defect region 31 can be expressed by a numeric vector having the six feature parameters.

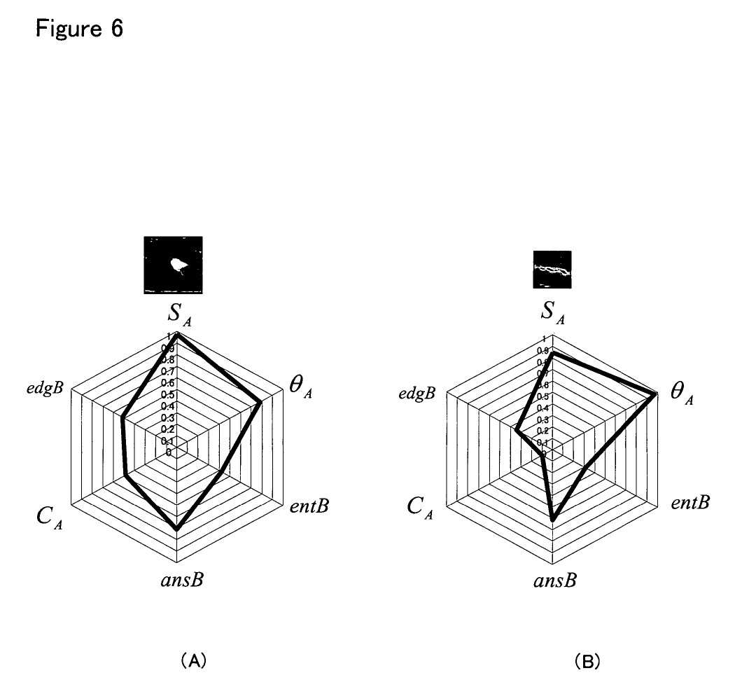

FIG. 6 shows feature vectors thus determined. (A) shows a feature vector corresponding to a dent shown in the image above the feature vector. (B) shows a feature vector corresponding to color unevenness (over-detection) on a gear tooth surface. As to the area S_{A} of the potential defect region, the slope θ_{A} of the major axis when the ellipse approximation is performed, and the anisotropy ansB, there is no significant difference between the both vectors. However, there is a significant difference as to the intensity value entropy entB, the roundness, and the average intensity edgB of the edge image.

Referring again to FIG. 2, a feature extracting unit 29 extracts a feature vector from the inspected region 33 as described above. In one embodiment, the feature extracting unit 29 extracts a feature vector of the above-described six parameters. In an alternative embodiment, the feature extracting unit 29 may extract a feature vector of three parameters of the intensity value entropy of the inspected region, the roundness of the potential defect region, and the average intensity of the edge image.

A determination unit 30 calculates a distance between a feature vector of a defect model that is pre-generated based on many samples of the inspected region 33 and a feature vector which is extracted by the feature extracting unit 29 for a gear tooth currently inspected. The determination unit 30 determines a surface condition of the gear tooth based on the calculated distance. The determination unit 30 in accordance with a first embodiment determines a defect if there is a defect model for which the calculated distance is smaller than a determination threshold value. On the other hand, if there is no defect model for which the calculated distance is smaller than the determination threshold value, the determination unit 30 determines that what is detected for the inspected region is an over-detection, not a defect. The determination unit 30 in accordance with an alternative second embodiment is configured with a neuro-computer having a learning capability, which will be described later.

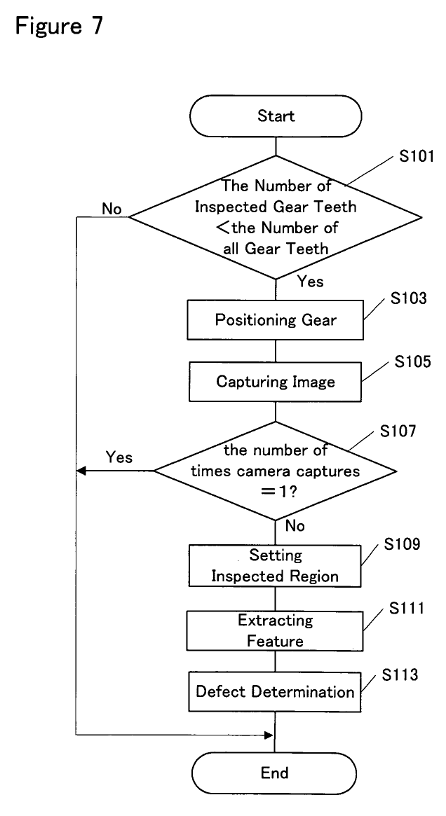

FIG. 7 shows a flowchart of a process for determining a surface condition of a gear tooth in accordance with one embodiment of the present invention. This process is repeated until the determination is completed for all the gear teeth surfaces. The process is started after the gear 11 has been attached on the rotary table 15 of FIG. 1 and the illumination device 19 has been activated.

In step S101, it is determined whether or not all the gear teeth surfaces have been inspected. If all the gear teeth surfaces have not been completed, the process proceeds to step S103. The number of teeth of the gear 11 has been set in a counter. The counter value is decremented every time the process in the figure is completed for each tooth. The determination in step 101 can be achieved by checking the counter value.

In step S103, the gear 11 is rotated by one tooth. The gear 11 stops at a position where the positioning sensor 18 indicates “on” state. The positioning sensor 18 is configured to output a signal when the gear 11 reaches a predetermined position. The timing unit 24 of the computer 23 sends a driving signal to the camera 21 in response to the signal from the positioning sensor 18. In response to the driving signal, the camera 21 captures an image of the gear 11 and sends the image to the computer 23 (step S105). In step S107, when the number of times that the camera captures the image is one, in other words, when the image for the first tooth of the gear is just taken, the differential image cannot be calculated. The image of the first tooth is stored. In order to capture the next image, subsequent steps S109-S113 are skipped and the initial process terminates. The process is then re-started.

In step S109, a differential image is generated from the images of two consecutive teeth as described above to select the inspected region 33 surrounding the potential defect region 31 (FIG. 3). In step S111, a feature vector is extracted from the differential image as described above referring to FIG. 6.

In step S113, a defect determination is performed. According to the above-described first embodiment, a distance is calculated between a feature vector for the current inspected region and a feature vector of each of a plurality of defect models which is prepared in advance. A defect is determined if there is a defect model for which the calculated distance is smaller than a determination threshold value. If there is no defect model for which the calculated distance is smaller than the determination threshold value, it is determined that the current inspected region represents an over-detection, not a defect.

According to the above-described second embodiment, in step S113, a determination data map is generated by using a neuro-computer and the defect determination is performed by using the generated determination data map.

Now, a determination implemented by the determination unit 30 in accordance with the second embodiment will be described. A method for generating a determination data map through self-organizing learning by a neural network will be described. Then, a method for determining a defect by using the determination data map will be described.

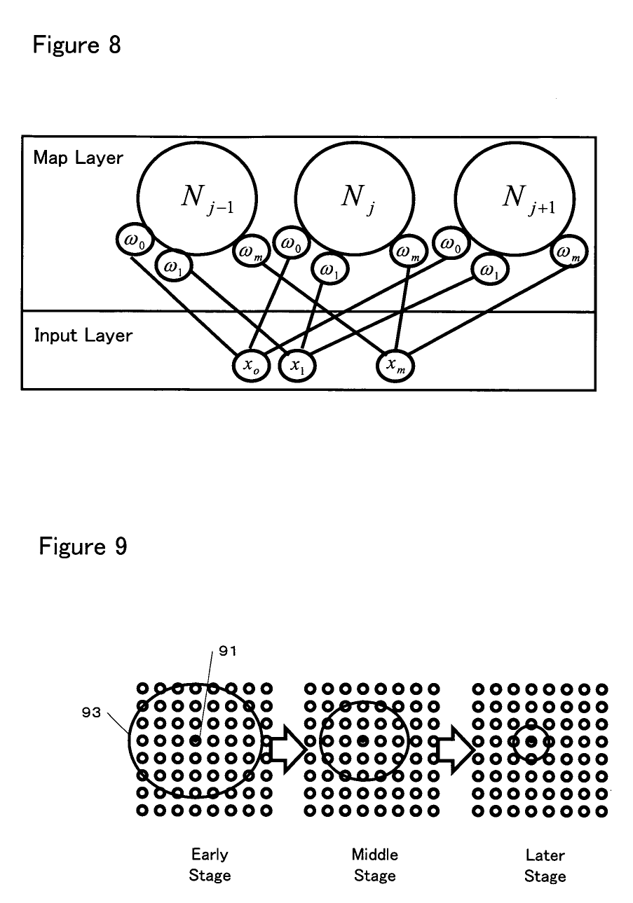

In this example, a self-organizing map is generated by using 40×40 neurons. FIG. 8 shows three neurons Nⱼ₋₁, Nⱼ and Nⱼ₊₁. ωⱼ=(ωⱼ₀, ωⱼ₁, . . . , ωⱼₘ) is a coupling coefficient vector for a neuron Nⱼ and x=(x₀, x₁, . . . , xₘ) is an input vector. The input vector in this embodiment is a feature vector that is extracted from the inspected region 33 by the feature extracting unit 29 (FIG. 2).

The self-organizing map is sometimes referred to as a self-organizing feature map, which is based on an unsupervised learning algorithm. This map automatically learns by extracting a feature hidden in the input data. The map thus self-organized is capable of selectively responding to the input data. The self-organizing map was proposed by Kohonen and is described in, for example, “A neuro-fuzzy genetic algorithm” published by Sangyo-Tosho in 1994.

A self-organizing map is generated according to the following steps.

Step 1: Network Initialization

The coupling coefficient vector ωⱼ=(ωⱼ₀, ωⱼ₁, . . . , ωⱼₘ) for each of all neurons is established by using random numbers.

Step 2: Input of a vector

The input vector x=(x₀, x₁, . . . , xₘ) is given to each neuron. A relationship between each neuron and the input vector is shown in FIG. 8.

Step 3: Calculation of a Distance Between the Coupling Coefficient Vector of Each Neuron and the Input Vector

A distance between the coupling coefficient vector of each neuron and the input vector is calculated in accordance with the equation (6).

$${d}_{j} = \sqrt{{\sum }_{l = 0}^{m} {( {χ}_{l} - {ω}_{jl} )}^{2}} \qquad ( 6 )$$

Step 4: Determination of a Winner Neuron

A neuron having the minimum distance dj is selected as a winner neuron, which is represented by j*.

Step 5: Learning of the Coupling Coefficient Vector

The coupling coefficient vector (weight) for each of the winner neuron and neurons in the neighborhood of the winner neuron is updated in accordance with the equation (7).
Δωⱼᵢ=ηh(j, j*)(χⱼ−ωⱼᵢ) (7)
η=0.05

η is a positive constant, which is 0.05 in this embodiment. h(j, j*) is referred to as a neighborhood function, which is expressed by the equation (8).

$$h ( j , j *) = exp ( - \frac{{\vert j - j * \vert}^{2}}{2 {σ ( t )}^{2}} ) \\ σ ( t ) = \frac{σ ( 0 )}{0.005 t + 1} \\ σ ( 0 ) = 5.0 \qquad ( 8 )$$

σ(t) becomes smaller as the learning progresses. Therefore, as shown by a circle in FIG. 9, the extent of the neighborhood function is wider at the early stage of the learning. As the learning progresses, the extent of the neighborhood function becomes narrower. In other words, as the learning progresses, adjustment changes from coarse to fine. Thus, the neighborhood function effectively generates the map. In FIG. 9, the winner neuron is shown by a small circle 91 and the neighborhood function surrounding the winner neuron is shown by a large circle 93.

Step 6: Update of t and Return to Input Process of a Vector

After the number of times of learning is updated from t to t+1, the process returns to the input of the input vector in step 2. Then, step 2 to step 6 are repeated. Thus, the coupling coefficient vector is repeatedly updated.

In the self-organizing map, the winner neuron and its neighboring neurons approach the current input vector. At the early stage of the learning, a coarse map is generated because many neurons are considered to be in the neighborhood of the winner neuron. As the learning progresses, the number of neurons which are considered to be in the neighborhood of the winner neuron by the neighborhood function decreases. Accordingly, local fine adjustment proceeds, thereby increasing the spatial resolution.

A plurality of samples of the inspected region 33 are used to generate the self-organizing map. By selecting sequentially or at random from the feature vectors of the plurality of samples and inputting them into the self-organizing map, the self-organization map that reflects similarity among the input feature vectors can be generated. As a result, clusters each having similar features are generated in the self-organizing map.

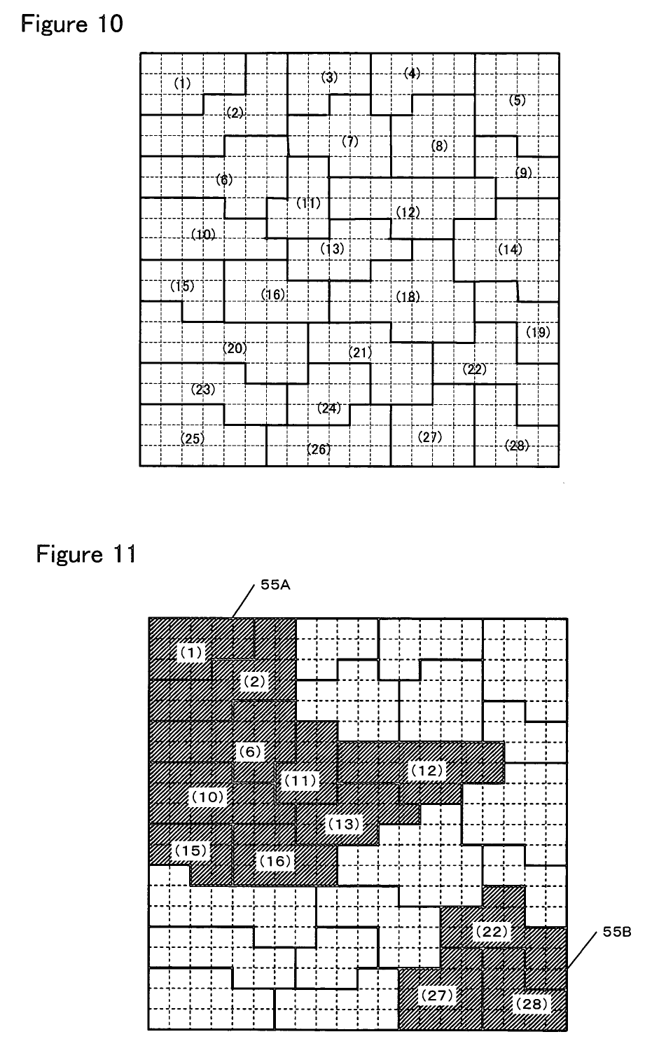

FIG. 10 shows an example of the self-organizing map thus generated. Although 40×40 neurons are used in the above-described embodiment, 20×20 neurons are shown in the figure for the purpose of simplicity. In the figure, each cell represents one neuron. Each of blocks (1), (2), . . . , (28), which are separated with solid lines, represents one cluster. The clusters are determined as follows.

At each neuron position in the self-organizing map, an image of the inspected region having a feature vector whose distance from the connection vector at the neuron position is the smallest is placed. As described above, this inspected region is one of the plurality of samples which are used for generating the self-organizing map. Adjacent neurons having the same image are selected and grouped. Such a group of neurons is called a cluster. The grouping function used in this embodiment is equivalent to that used in conventional drawing programs. Grouped neurons can be selected as a group and given its own property.

Then, the image placed in each cluster is checked by visual observation to determine whether the inspected region includes a defect or over-inspection (for example, surface unevenness). The result of this determination is recorded in the property of the cluster. More specifically, “over-detection” is initially set in the property field of each cluster. The self-organizing map is displayed on a display device of the computer. The cluster that has been determined to have a defect is right-clicked by the mouse and the property field of the cluster is changed to “defect”. Thus, since neurons can be classified on a cluster-by-cluster basis, the time required for determining a surface condition can be shortened.

FIG. 11 shows a map (determination data map) in which clusters are classified in accordance with the above-described method. A block 55A including hatched clusters (1), (2), (6), (10), (11), (12), (13), (15) and (16) and a block 55B including hatched clusters (22), (27) and (28) represent clusters that are classified as “defect”. The other non-hatched clusters represent clusters that are classified as “over-detection”. This determination data map is stored in the storage device of the computer 23 (FIG. 2), which can be used to determine presence/absence of a defect by the determination unit 30. The defect determination will be described.

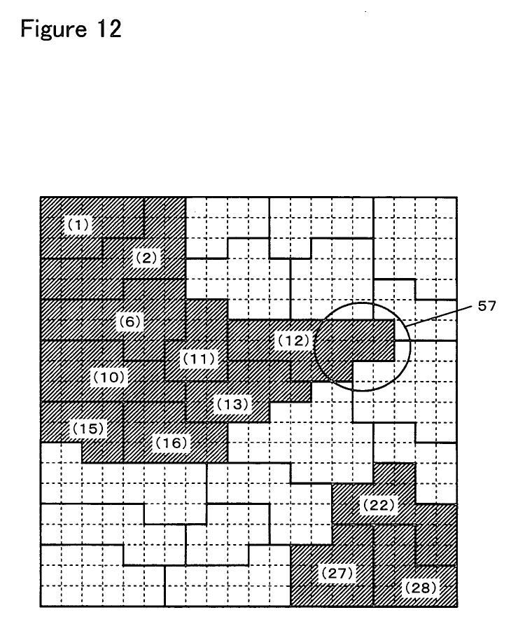

The determination unit 30 calculates a distance between the feature vector received from the extracting unit 29 and the coupling coefficient vector of each neuron. This distance is calculated in accordance with the above equation (6). Neurons are selected in increasing order of the calculated distance. A predetermined number of neurons (for example, 10 neurons or less) are selected. A circle or ellipse surrounding these neurons is set as a neighboring region. In the generation process of the determination data map, neurons whose coupling coefficient vectors approximate each other have been grouped into one cluster. Therefore, by selecting neurons in increasing order of the distance, a collection of neurons which are adjacent to each other is selected. A circle or ellipse surrounding the collection of neurons is set as a neighboring region. Referring to FIG. 12, for example, a circle 57 defines a neighboring region.

The circle 57 can be specifically determined by determining a center position of the collection of selected neurons in the determination data map, determining a distance from the center position to a neuron which is located at the farthest position among the collection of the neurons, and drawing the circle 57 with a radius of the distance thus determined.

The defect determination is performed based on a ratio of the number (K) of neurons belonging to the defect cluster in the neighboring region defined by such a circle or ellipse, relative to the total number (S) of neurons included in the neighboring region. The ratio can be expressed by (K)/(S). If (K)/(S)≧D, it is determined that there is a defect. If (K)/(S)<D, it is determined that there is an over-detection. D is a predetermined threshold value, which is, for example, 0.5. Thus, presence/absence of a defect or over-detection is determined. In the example shown in FIG. 12, in the circle 57, there are 8 neurons that belong to the defect cluster (12). The total number of neurons within the circle 57 is 12. Therefore, (K)/(S)=8/12=0.67, which results in a determination that what is included in the inspected region is a defect.

Then, a gear tooth surface where the presence of a defect has been determined through the above automatic determination by the computer using the determination data map is inspected by visual observation so as to confirm the defect. A gear tooth surface where the presence of an over-detection is determined through the automatic determination may be also confirmed by visual observation. The feature vector of the inspected region of the gear tooth surface that is finally determined as including a defect is input into the self-organizing map before the clustering process so that the self-organizing map can learn. At this time, the latest coupling coefficient vector which has been generated during the past learning process is used as an initial value of the coupling coefficient vector for each neuron of the self-organizing map.

Thus, the self-organizing map is updated and the above-described clustering process is again performed. In doing so, a cluster corresponding to a new type of defect or over-detection can be created. The accuracy of the inspection can be improved by using the determination data map thus updated. Because the coupling coefficient vectors determined in the past are used in this update process, the determination data map can be updated with short-time learning.

Depending on which part of the object is imaged, a different feature that can be easily distinguished may appear in the image of the object. For example, when an image of an end part of the inspected object is captured, the image may partially include something different from the inspected object (for example, a background). In contrast, when an image of a center part of the object is captured, the object may extend over the entire image. A feature between an image including the background and an image without the background is clearly different regardless of presence/absence of a defect. If the same self-organizing map is applied to the images having such an easily-distinguishable different feature, the accuracy of determining the surface condition of the inspected object may deteriorate. Increasing the number of neurons of the self-organizing map may be one solution for improving the accuracy of determining the surface condition of the inspected object. However, increasing the number of neurons may cause an increase of the time required for the determination process.

A third embodiment of the present invention, which can solve the above problem, will be described.

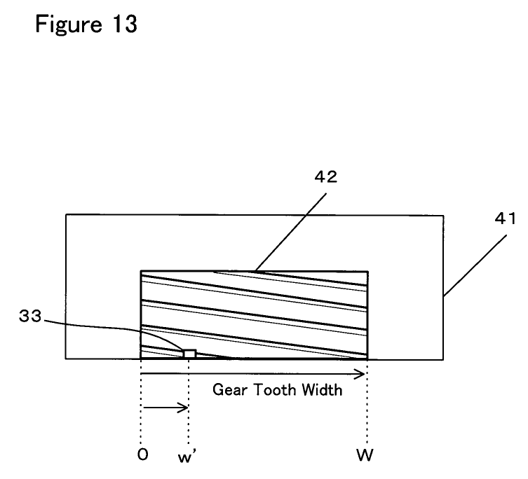

The inspected region setting unit 28 shown in FIG. 2 stores position information of the inspected region 33 in the storage device of the computer 23. FIG. 13 show an example of the captured image 41 of a gear tooth surface. Reference numeral 42 indicates the gear captured in the image. The inspected region 33 is set in the image 41. A tooth width of the gear is W. A position of the inspected region 33 in the tooth width direction is identified by w′. Thus, the position information of the inspected region 33, including the position of the gear in the tooth width direction, is stored in the storage device of the computer 23.

The determination unit 30 reads the position information of the inspected region 33 stored in the storage device by the inspected region setting unit 28. Because the camera 21 and the base seat 17 (FIG. 1) on which the gear is attached are fixed, a position at which the gear is present in the image is predetermined. Therefore, the position information of the inspected region indicates a part of the gear to which the inspected region belongs. Based on the position information, the determination unit 30 identifies the part of the gear to which the inspected region belongs and selects a determination data map corresponding to the part to which the inspected region belongs. The determination unit 30 applies a feature vector extracted by the feature extracting unit 29 to the selected determination data map so as to determine the surface condition of the inspected region 33.

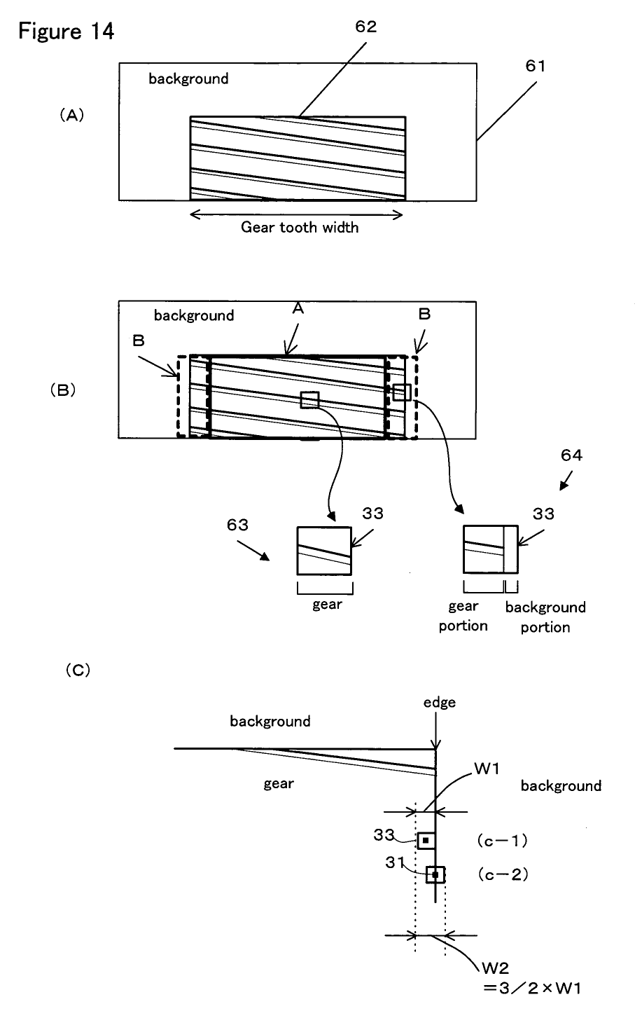

Referring to FIG. 14, an example of a method for identifying a part of a gear to which the inspected region 33 belongs will be described. As shown in (A), the gear is captured in an image 61. An image region where the gear is present is indicated by reference numeral 62. In the image 61, a background is present in a region other than the gear region 62. As shown in (B), a center region A (surrounded by a bold black line) and an end region B (surrounded by bold dashed lines) are defined in the image. The center region A indicates a center part of the gear. As shown by reference numeral 63, when the inspected region is set in the center region A, the entire inspected region 33 is covered by the gear image. The end region B indicates an end part (edge) of the gear. When a defect or over-detection is present in the end part of the gear, the inspected region 33 is set in the end region B, as shown by reference numeral 64. The gear is imaged in a portion of the inspected region 33. In the other portion of the inspected region 33, the background is imaged.

Thus, the inspected region 33 that is set in the end region B includes the gear portion and the background portion. The inspected region 33 that is set in the center region A includes only the gear portion. The two inspected regions have clearly a different feature regardless of presence/absence of a defect or over-detection. In this embodiment, a first determination data map is prepared for the center region A and stored in the storage device and a second determination data map is prepared for the end region B and stored in the storage device. The determination unit 30 determines the surface condition using the first determination data map when it is determined from the position information that the inspected region 33 belongs to the center region A. The determination unit 30 determines the surface condition using the second determination data map when it is determined from the position information that the inspected region 33 belongs to the end region B.

Thus, in a case where a different feature appears in the inspected region depending on which part of the object is imaged, it is preferable that a determination data map corresponding to each feature is used. In doing so, the amount of each determination data map can be reduced, and hence the accuracy and efficiency for determining the surface condition of a gear can be improved.

Because the position of the region 62, where the gear is captured, relative to the image is predetermined, the positions of the center region A and the end region B relative to the image can be predetermined. The width W2 of the end region B is typically determined in accordance with the width W1 (in the lateral direction) of the inspected region 33. FIG. 14(C) shows an enlarged right-side edge of the gear, where two examples of the inspected region 33 that are set to surround the potential defect region 31 are shown. It is assumed that the inspected region 33 is set in such a manner that the potential defect region 31 is placed almost in the center of the inspected region. (c-1) indicates a case where the right end of the inspected region 33 reaches the edge of the gear and (c-2) indicates a case where the almost center of the inspected region 33 is present on the edge of the gear.

If the inspected region 33 deviates to the right from the position shown in (c-1), the background is included in the inspected region 33. Therefore, it is preferable that the end region B is at least set in such a manner that it has a width of W1 in the gear side and a width of (½×W1) in the background side. After the position of the end region B is determined, the remaining region of the gear image 62 is set as the center region A.

When the inspected region 33 extends across both the central region A and the end region B, the region (the center region A or the end region B) to which the inspected region 33 belongs may be decided depending on which of the center region A and the end region B the position of the potential defect region 31 in the inspected region 33 belongs to. Alternatively, the region to which the inspected region 33 belongs may be decided in accordance with a ratio between the area covered by the center region A and the area covered by the end region B in the inspected region 33.

In this embodiment described above, two regions (the center region A and the end region B) are set depending on whether the inspected region includes the background or not. Alternatively, when a different feature appears between one part and another part of the inspected object because of, for example, a structural difference between the two parts, a determination data map can be prepared for each of the two parts.

In the above-described preferred embodiments, when there is a different feature between parts of an inspected object, a determination data map for each part is prepared. However, even when there is no different feature between parts, a determination data map for each part can be prepared.

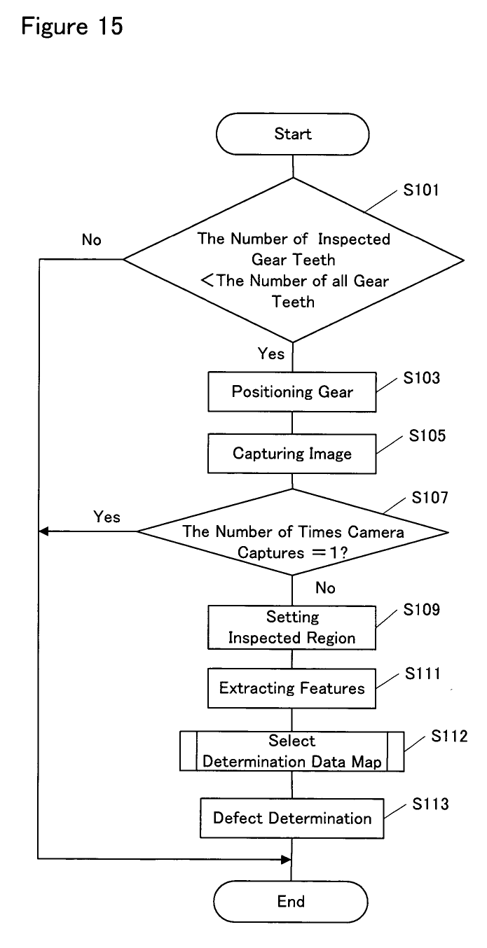

FIG. 15 shows a flowchart of a process for determining a surface condition of a gear tooth surface in accordance with the third embodiment of the present invention. The process differs from the process shown in FIG. 7 in that step S112 for selecting a determination map is added. In step S113, a defect determination is performed by using the determination data map selected in step S112. Since the other steps are the same as those shown in FIG. 7, description for these steps will be omitted.

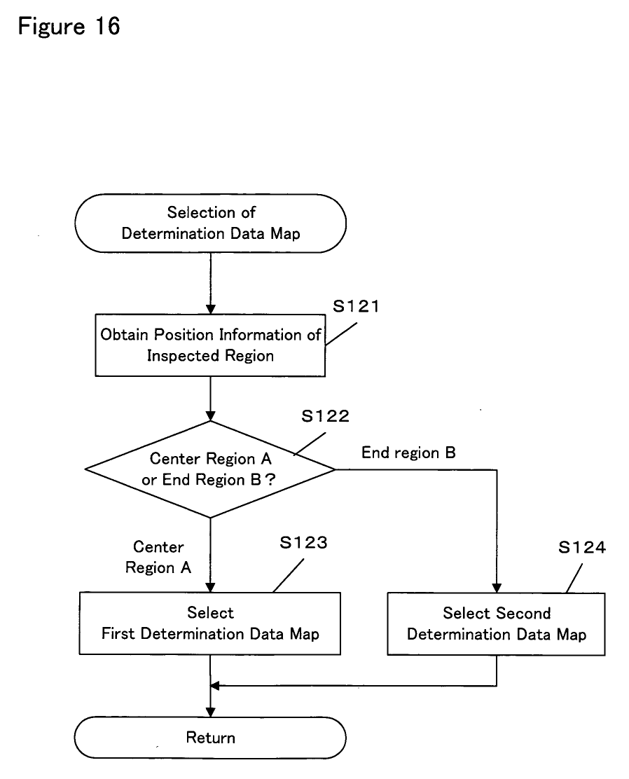

FIG. 16 shows a flowchart of a routine performed in step S112 of FIG. 15. In step S121, the position information of the inspected region 33 is obtained. In step S122, it is determined whether the inspected region 33 belongs to the center region A or the end region B, based on the position information of the inspected region 33. If it belongs to the center region A, a first determination data map is selected in step S123. If it belongs to the end region B, the second determination data map is selected in step S124. Thus, when the inspected region 33 belongs to the center region A, the surface condition is determined by using the first determination data map. When the inspected region 33 belongs to the end region B, the surface condition is determined by using the second determination data map.

The first and second determination data maps are generated in accordance with the above-described method. The first determination data map is generated based on a first self-organizing map and the second determination data map is generated based on a second self-organizing map. Input vectors are different between the first and second self-organizing map generation. If a sample of the inspected region 33 is set in the center region A, the feature vector of the inspected region 33 is input into the first self-organizing map. If a sample of the inspected region 33 is set in the end region B, the feature vector of the inspected region 33 is input into the second self-organizing map.

The first and second determination data maps thus generated are stored in the storage device of the computer 23. The first determination data map is a map appropriate to the center region of the gear. The second determination data map is a map appropriate to the end region of the gear. The determination unit 30 performs a defect determination using the first or second determination data map in a similar way as described above.

Using a self-organizing map to determine a surface condition of an inspected object can improve the accuracy of the determination. However, if such a computation-intensive process is performed for all of the inspected regions potentially including a defect or over-detection, the time required for the determination may increase.

A determination in accordance with a fourth embodiment of the present invention, which can solve the above problem, will be described.

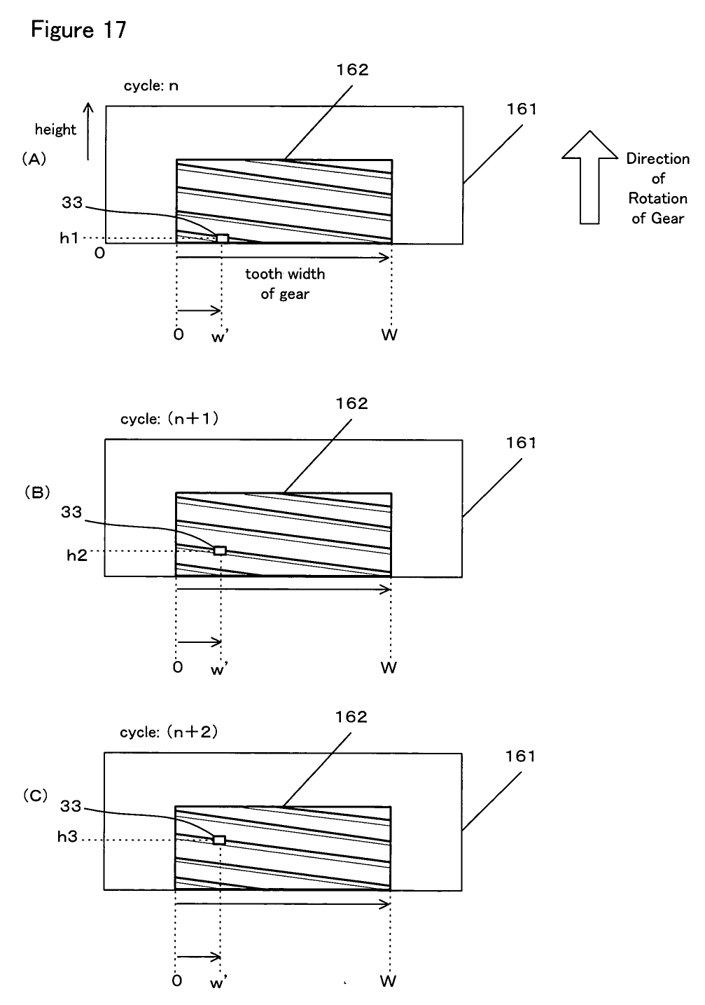

FIG. 17 shows an example of three consecutive images 161 of a gear, each of which is captured each time the gear is rotated by one tooth. Reference numeral 162 indicates the gear captured in the image 161. A tooth width of the gear is represented by “W.” An imaging cycle is represented by “n.” (A) shows an image captured at the n-th cycle, (B) shows an image captured at the (n+1)-th cycle, and (C) shows an image captured at the (n+2)-th cycle. The inspected region 33 is set in these images. Over the n-th, (n+1)-th and (n+2)-th cycles, the inspected region 33 moves in the direction of the height of the image, as shown h1, h2 and h3, but its position in the direction of the tooth width of the gear is maintained at w′.

Differently from an over-detection such as color unevenness, a defect such as a dent or cut on the surface of a gear has the characteristics that reflect illumination light in various directions. Because of the characteristics of a defect, when images are sequentially captured while the gear is rotated relatively to the camera, a defect is detected at the same position in the direction of the tooth width of the gear over a plurality of consecutive images. In other words, when the inspected region includes a defect, the inspected region is detected at the same position in the direction of the tooth width of the gear over a plurality of consecutive images, as shown in FIG. 17. Thus, depending whether or not the inspected region is set at the same position over a plurality of consecutive images, a defect can be efficiently distinguished from an over-detection such as color unevenness or stain.

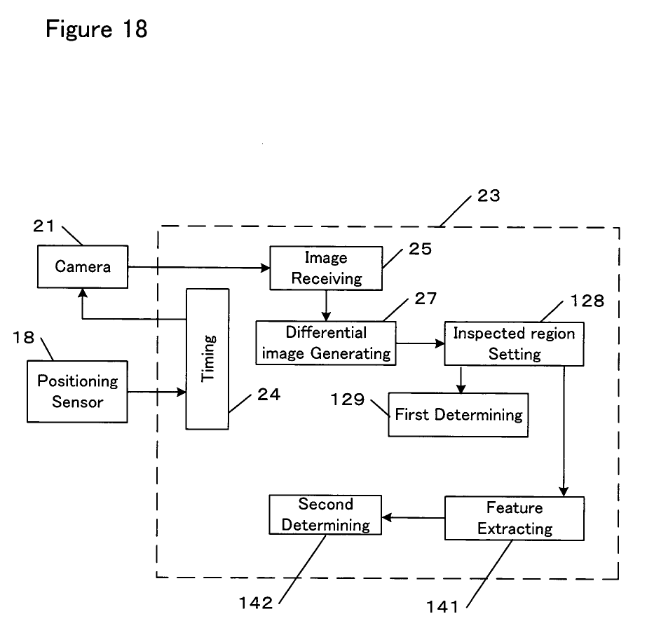

FIG. 18 shows a functional block diagram of the computer 23 in accordance with the fourth embodiment. For blocks having the same functions as in FIG. 2 are given the same reference numerals, description will be omitted. Blocks having different reference numerals will be described.

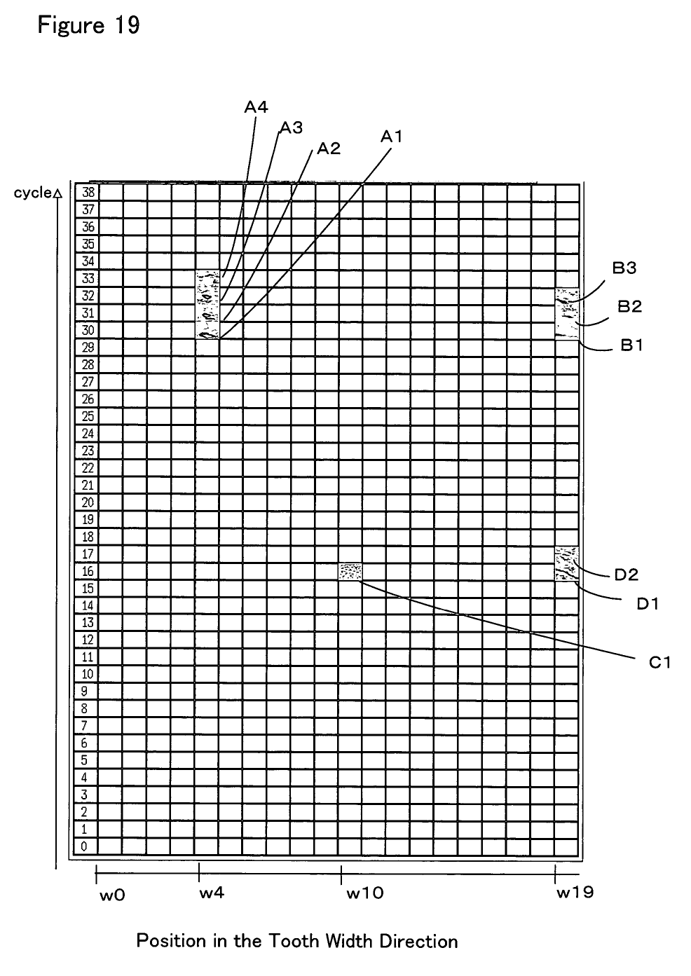

An inspected region setting unit 128 stores position information of the inspected region (in this example, a position in the tooth width direction and a cycle in which the inspected region is set) and images of the inspected region, as a map shown in FIG. 19, in the storage device of the computer 23. Referring to FIG. 19, a horizontal axis indicates a position in the tooth width direction of the gear and a vertical axis indicates a cycle number. In this example, the tooth width W of the gear is equally divided into 20, so that the position in the tooth width direction can be identified by w0 through w19. Since the imaging is performed each time the gear rotates by one tooth and the number of teeth of the gear is 39 in this example, the cycle number ranges from 0 to 38. A specific tooth of the gear is identified by the cycle number. A1 to A4 indicate that the inspected region 33 is identified in the 30th to 33rd cycles at a position of W4 in the tooth width direction. B1 to B3 indicate that the inspected region 33 is identified in the 30th to 32nd cycles at a position of W19 in the tooth width direction. C1 indicates that the inspected region 33 is identified in the 16th cycle at a position of W10 in the tooth width direction. D1 and D2 indicate that the inspected region 33 is identified in the 16th and 17th cycles at a position of W19 in the tooth width direction.

A first determination unit 129 accesses the storage device to read information about the position in the tooth width direction of the inspected region 33 and the cycle number(s) in which the inspected region 33 is set. The first determination unit 129 determines whether or not the inspected region 33 has been set consecutively at the same position in the tooth width direction more than a predetermined number of times (for example, 3 times). If the inspected region 33 is set in the same position in the tooth width direction more than the predetermined number of times as shown in the cases of A1 to A4 and B1 to B3, it is determined that the inspected region includes a defect as described above referring to FIG. 17. The inspected regions C1 and D1 to D2, other than the region determined as including a defect, are determined as regions for which further inspection is required (this region will be hereinafter referred to as inspection-required region). Since further detailed inspection is required for the inspection-required region, this region is provided to a feature extracting unit 141 and a second determination unit 142.

The feature extracting unit 141 extracts a feature vector from the inspection-required region determined by the first determination unit 129. The extraction method is the same as that performed by the feature extracting unit 29 of FIG. 2.

The second determination unit 142 determines a surface condition based on the feature vector extracted by the feature extracting unit 141. The surface condition can be determined according to the above-described first or second embodiment. According to the first embodiment, the defect determination is performed based on a distance between the feature vector extracted by the feature extracting unit 141 and the feature vector of a pre-generated defect model. According to the second embodiment, the defect determination is performed by using a determination data map generated based on a self-organizing map.

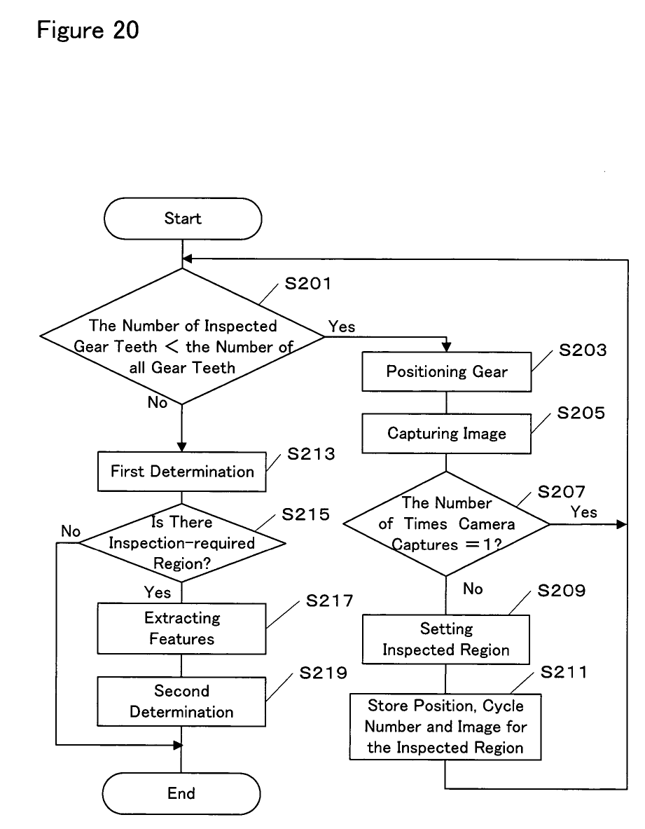

FIG. 20 shows a flowchart of a process for determining a surface condition for each gear tooth surface in accordance with the fourth embodiment of the present invention. Description of steps S201 through S209 will be omitted because these are the same as steps S101 through S109 in FIG. 7.

In step S211, for the inspected region 33 set in step 209, the position in the gear tooth width direction, the counter value in step S201 (this value identifies the cycle number) and the image are stored. Then, the process returns to step S201.

When the decision in step S201 is “No”, the position of the inspected region in the gear tooth width direction, the cycle in which the inspected region is set and the image of the inspected region have been stored for all teeth of the gear, and hence a map as shown in FIG. 19 can be generated.

In step S213, referring to the map, it is determined whether there is an inspected region that has been set at the same tooth width direction over a predetermined number of consecutive cycles. If so, it is determined that the inspected region includes a defect (first determination).

In step S215, referring to the map, it is determined whether there is an inspection-required region. If so, in step S217, a feature vector is extracted from the inspection-required region. In step S219, a distance between the extracted feature vector and the feature vector of a pre-generated defect model is calculated to determine whether or not the inspection-required region includes a defect (second determination).

According to this embodiment, the first determination determines whether the inspected region includes a defect according to whether the inspected region is identified at the same position on the gear over more than a predetermined number of consecutive images. Thus, the determination can be efficiently performed by using the characteristics of a defect. Further, as to each of the remaining inspected regions in which a defect is not determined in the first determination, the second determination determines whether the inspected region includes a defect by comparing the feature vector extracted from the inspected region with the feature vector of a predetermined defect model or by using a self-organizing map. The second determination can make the defect determination more accurate for the inspected region in which a defect is not determined in the first determination. Through such two-stage determinations, the defect determination can be performed efficiently and accurately.

The surface of a gear is exposed to various processes such as manufacturing process, storage process and so on. In these processes, a defect such as a dent or cut may be marked on the surface of the gear. If a cause of generation of a surface condition such as a defect can be automatically identified, management for a manufacturing, storage and other processes of the gear can be efficiently improved.

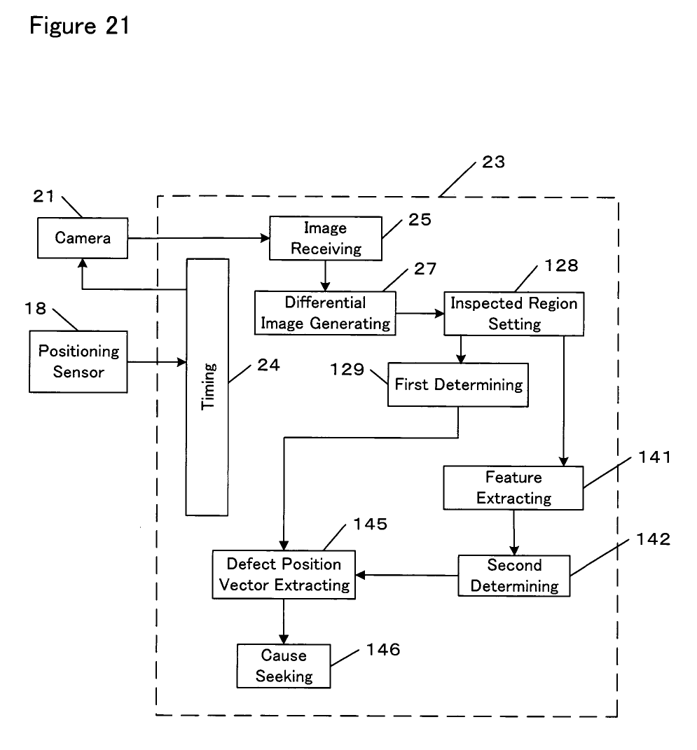

A fifth embodiment of the present invention provides an apparatus and method that can automatically identify a cause of a surface condition such as a defect. FIG. 21 shows a functional block diagram of the computer 23 in accordance with the fifth embodiment. Blocks having the same functions as in FIG. 18 are given the same reference numerals. Description for these blocks will be omitted. Blocks having different reference numerals will be described.

The storage device in the computer 23 stores the position in the tooth width direction of each inspected region of a gear when the first and the second determination units 129 and 142 determine that the inspected region includes a defect. A defect position vector extracting unit 145 reads this position information to calculate a defect position vector for each gear. The defect position vector, which is expressed by the following equation (9), indicates a position in the tooth width direction at which the inspected region determined as including a defect is placed.
defect position vector=(w0, w1 and w2. . . . , w19) (9)

As described above, vector elements w0 to w19 represent respective positions in the tooth width direction of the gear. A value of 1 is set in the positions at which the presence of a defect is determined and a value of 0 is set in the other positions. In the example of the gear shown in FIG. 19, the defect position vector is expressed as (0, 0, 0, 0, 1, 0, 0, 0, 0, 0, 0, 0, 0, 0, 0, 0, 0, 0, 0, 1) because a defect is detected at the positions of w4 and w19.

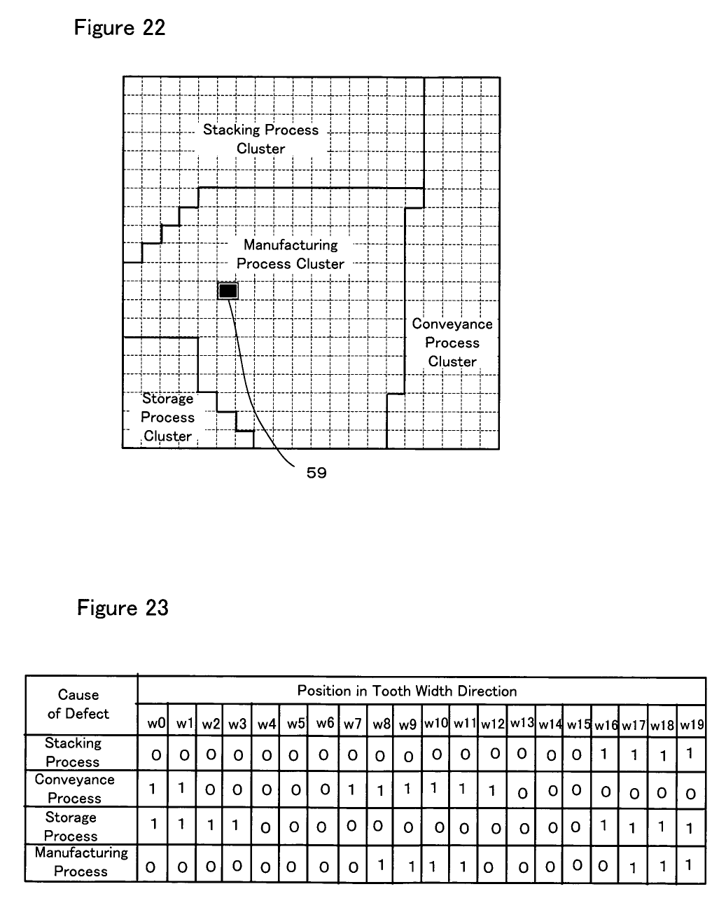

A cause seeking unit 146 inputs the defect position vector into a cause seeking map. The cause seeking map is a self-organizing map where neurons are clustered for each of causes of a defect. The map is stored in the storage device of the computer 23. An example of the cause seeking map is shown in FIG. 22. Each cell represents a neuron. In this example, neurons are grouped into a manufacturing process cluster where the cause of a defect exists in the manufacturing process of the gear, a stacking process cluster where the cause of a defect exists in the stacking process for the manufactured gear, a conveyance process cluster where the cause of a defect exists in the conveyance process for carrying the gear, and a storage process cluster where the cause of a defect exists in the storage process for storing the gear in a warehouse or the like.

The cause seeking unit 146 determines a cause in a similar way to the second embodiment. Specifically, the cause seeking unit 146 calculates a distance between the defect position vector extracted by the defect position vector extracting unit 145 and the coupling coefficient vector of each neuron in the cause seeking map. This distance is calculated as shown by the above equation (6). A neuron having the minimum distance is extracted. A cluster to which the extracted neuron belongs is identified and this identified cluster indicates a process where the defect has been formed. For example, if a neuron having the minimum distance between a defect position vector for a gear and the coupling coefficient vector of the neuron is indicated by reference numeral 59 (FIG. 22), it can be estimated that the defect of the gear has been formed in the manufacturing process.

A method for generating a cause seeking map will be described. A cause seeking map is generated by using, as input data, defect position vectors prepared for learning. An example of the defect position vectors for learning is shown in FIG. 23. These vectors are prepared in advance as a result of investigation of a relationship between a defect position and its corresponding cause for a plurality of gears. For example, as to the stacking process in which gears are stacked, it is known that the edge (end) on one side of a gear, for example, w16 to wl9 positions in the tooth width direction, is likely to be damaged. Therefore, a value of 1 is set in the vector elements w16 to wl9 of the defect position vector for the stacking process.

A method for generating a self-organizing map by using the defect position vectors as input data is similar to generating the self-organizing map for the above-described determination data map. Specifically, after the network initialization in step 1 has been performed, steps 2 through 6 are repeated. As the learning progresses by repeatedly inputting a defect position vector for learning into the self-organizing map, the extent of neurons responding to each defect position vector is gradually defined, as shown by clusters of FIG. 22. Thus, the cause seeking map in which neurons are clustered for each of causes of a defect is generated. The generated cause seeking map is stored in the storage device.

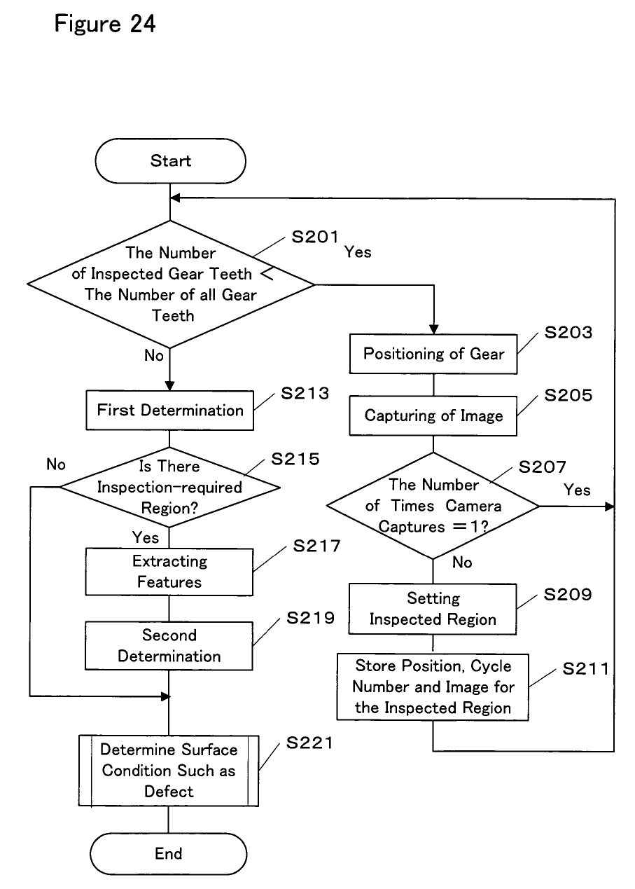

FIG. 24 shows a flowchart of a process for determining a surface condition of each gear tooth surface in accordance with the fifth embodiment of the present invention. The process differs from the process shown in FIG. 20 of the fourth embodiment in that step S221 is added. In step S221, a routine for determining a cause of a defect is performed.

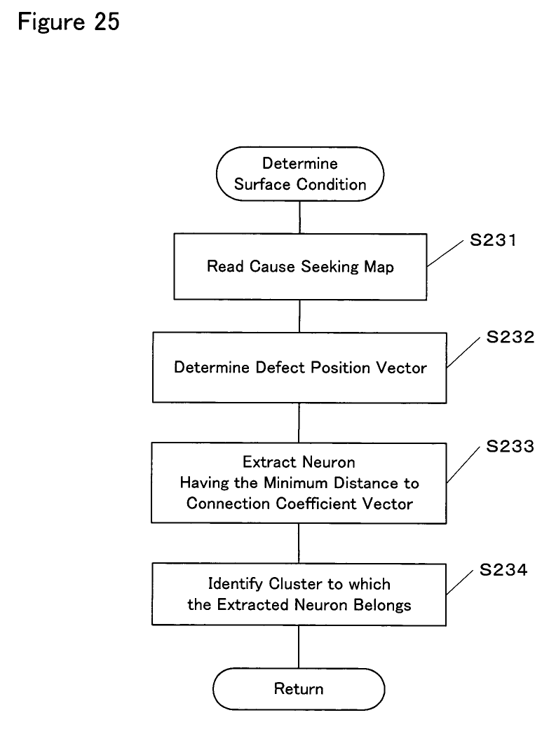

FIG. 25 is a flowchart of a process performed in step S221 of FIG. 24 for determining a cause of a defect for a gear. In step S231, a cause seeking map as shown in FIG. 22 is read from the storage device. In step S232, information about each inspected region of the gear is read from the storage device, to calculate a defect position vector based on the position in the tooth width direction of the inspected region which has been determined as including a defect in step S213 and S219 of FIG. 24. In step S233, a distance between the defect position vector and the coupling coefficient vector of each neuron in the cause seeking map is calculated to identify a neuron having the minimum distance. In step S234, a cluster to which the identified neuron belongs is identified and the process in which the defect has been formed is determined by the identified by the cluster.

Alternatively, only defects of a gear which have been determined by the first determination unit 129 may be used so as to calculate a defect position vector that is to be input into the cause seeking map. Or, all inspected regions of a gear may be determined only by the second determination unit 142 so as to calculate a defect position vector.

The above-described embodiment identifies the process in which a defect is formed. Those skilled in the art would use the above described method to determine a process where a predetermined surface condition such as over-detection is formed.

Although the present invention has been described above referring to specific embodiments, the present invention should not be limited to such embodiments.

What is claimed is:

1. An apparatus using a computer for determining a surface condition of an inspected object, the apparatus comprising:
an imaging device for imaging the inspected object; and
an image processing unit configured to:
detect a potential region in the image of the inspected object, the potential region having an intensity different from the other regions in the image by more than a predetermined threshold value;
identify an inspected region surrounding the potential region;
extract a feature for a predetermined parameter from the inspected region; and
determine the surface condition based on the feature.

2. The apparatus of claim 1, wherein the parameter includes one or more of an area of the potential region, a slope of the potential region, an intensity value entropy of the inspected region, an intensity value anisotropy of the inspected region, an average intensity value of an edge image of the inspected region, and a roundness of the potential region.

3. The apparatus of claim 1, wherein the inspected object is a gear.

4. An apparatus using a computer for determining a surface condition of an inspected object, the inspected object having a plurality of consecutive units of similar texture on the surface, the apparatus comprising:
an imaging device for sequentially imaging the consecutive units on the surface of the inspected object while rotating the inspected object relatively to the imaging device; and
an image processing unit configured to:
determine a differential image between a current image and a previous image in the consecutive images;
detect a potential region having an intensity exceeding a predetermined threshold value in the differential image;
identify an inspected region surrounding the potential region;
extract a feature for a plurality of predetermined parameters from the inspected region; and
determine the surface condition based on the feature.

5. An apparatus using a computer for generating a data map to be used for determining a surface condition of an inspected object, the inspected object having a plurality of consecutive units of similar texture on the surface, the apparatus comprising an image processing unit configured to:
extract a feature vector from each of a plurality of samples of an inspected region of the inspected object;
self-organizing learn through use of the feature vectors to generate a self-organizing map;
group neurons that correspond to each same sample and are adjacent to each other into a cluster in the self-organizing map; and
classify one or more clusters as corresponding to a predetermined surface condition and the other one or more clusters as not corresponding to the predetermined surface condition to generate the data map.

6. The apparatus of claim 5, wherein the predetermined surface condition is a defect,
wherein the data map is generated by classifying one or more clusters as corresponding to the defect and the other one or more clusters as corresponding to an over-detection.

7. The apparatus of claim 5, further comprising an imaging device for sequentially imaging the consecutive units on the surface of the inspected object while rotating the inspected object relatively to the imaging device;
wherein the image processing unit is further configured to perform a determination using the data map, the determination including:
determining a differential image between a current image and a previous image in the images of the consecutive units;
detecting a potential region having an intensity exceeding a predetermined threshold value in the differential image;
identifying an inspected region surrounding the potential region;
extracting a feature vector for parameters from the inspected region; and
calculating a distance between the feature vector and a coupling coefficient vector of each neuron in the data map;
determining a region of adjacent neurons having a small distance; and
determining the surface condition based on the number of neurons that are in the determined region and belong to one of the clusters corresponding to the predetermined surface condition.

8. The apparatus of claim 7, wherein the image processing unit is further configured to, if a ratio of the number of neurons that are in the determined region and belong to one of the clusters corresponding to the predetermined surface condition to the number of all neurons in the determined region is greater than a predetermined threshold value, determine that the inspected region includes the predetermined surface condition.

9. The apparatus of claim 7, wherein the feature vector includes one or more of an area of the potential region, a slope of the potential region, an intensity value entropy of the inspected region, an intensity value anisotropy of the inspected region, an average intensity value of an edge image of the inspected region, and a roundness of the potential region.

10. The apparatus of claim 5, wherein the inspected object is a gear.

11. An apparatus for determining a surface condition of an inspected object, the apparatus comprising:
a storage device for storing a plurality of data maps provided for respective parts of the inspected object, each of the data maps learning a surface condition of the corresponding part of the inspected object; and
an imaging device for imaging the inspected object; and
an image processing unit configured to:
identify an inspected region in the image of the inspected object, the inspected region including a potential region that has an intensity different from the other regions in the image by more than a predetermined threshold value;
extract a feature vector from the inspected region;
identify a part of the inspected object to which the inspected region belongs;
select a data map corresponding to the identified part; and
input the feature vector into the selected data map to determine whether the inspected region has a predetermined surface condition.

12. The apparatus of claim 11, wherein the storage device stores a first data map that learns the predetermined surface condition in a first part of the inspected object, the first part being imaged over the entire inspected region, and a second data map that learns the predetermined surface condition in a second part of the inspected object, the second part being imaged in a portion of the inspected region.

13. The apparatus of claim 11, wherein the inspected object is a gear,
wherein the storage device stores a first data map that learns the predetermined surface condition in a center part of the gear, the center part being imaged over the entire inspected region, and a second data map that learns the predetermined surface condition in an end part of the inspected object, the second part being imaged in a portion of the inspected region.

14. The apparatus of claim of claim 11, wherein the image processing unit is further configured to generate a data map for each part of the inspected object,
wherein the generation of the data map includes:
(a) defining a self-organizing map for each part of the inspected object,
(b) preparing a plurality of samples of the inspected region, the preparing further including, for each of the samples of the inspected region,
(b1) extracting a feature vector from the inspected region;
(b2) identifying a part to which the inspected region belongs to select the self-organizing map corresponding to the part;
(b3) inputting the feature vector into the selected self-organizing map for learning;
(c) grouping adjacent neurons that correspond to each same sample into a cluster in the self-organizing map; and
(d) classifying one or more clusters as corresponding to the predetermined surface condition and the other one or more clusters as not corresponding to the predetermined surface condition to generate the data map.

15. An apparatus for determining a surface condition of an inspected object, the apparatus comprising:
an imaging device for sequentially imaging a surface of the inspected object while rotating the inspected object relatively to the imaging device; and
an image processing unit configured to:
detect a potential region having an intensity different from the other regions in each image by more than a predetermined threshold value;
identify an inspected region surrounding the detected potential region; and
determine that a predetermined surface condition is included in the inspected region when the inspected region is identified at the same position on the inspected object over a plurality of consecutive images captured by the imaging device.

16. The apparatus of claim 15, wherein the image processing unit is further configured to:
if the inspected region is identified at the same position on the inspected object over more than a predetermined number of consecutive images, determine that the predetermined surface condition is included in the inspected region;
for each inspected region other than the inspected region determined as including the predetermined surface condition, extract a feature from the inspected region for a plurality of parameters; and
determine whether the inspected region includes the predetermined surface condition based on the extracted feature.

17. The apparatus of claim 15, wherein the inspected object is a gear,
wherein the image processing unit is further configured to determine that the predetermined surface condition is included in the inspected region when the inspected region is identified at the same position in a tooth width direction of the gear over a plurality of consecutive images captured by the imaging device.

18. An apparatus for automatically determining a cause of a surface condition of an inspected object, the apparatus comprising:
a storage device for storing a cause seeking map in which neurons are clustered for each of causes of the surface condition in a form of a self-organizing map;
an imaging device for imaging the inspected object; and
an image processing unit configured to:
detect a potential region having an intensity different from the other regions in the image by more than a predetermined threshold value;
identify an inspected region surrounding the potential region;
determine whether the inspected region includes a predetermined surface condition;
identify position information of the inspected region determined as including the predetermined surface condition;
extract, from the position information, a position vector representing a position of the predetermined surface condition on the inspected object;
input the extracted position vector into the cause seeking map;
identify a neuron in the cause seeking map, the neuron having a minimum distance between the position vector that has been input into the cause seeking map and a coupling coefficient vector for the neuron; and
determine a cause of the predetermined surface condition in accordance with a cluster to which the identified neuron belongs.

19. The apparatus of claim 18, wherein the image processing unit is further configured to generate the cause seeking map by inputting a position vector prepared for learning, the position vector for learning identifying a position of the predetermined surface condition for each of causes of the predetermined surface condition.

20. The apparatus of claim 18, wherein the inspected object is a gear,
wherein the position vector is expressed by respective positions in a gear tooth width direction.
